(19) United States
(12) Patent Application Publication
(10) Pub. No.: US 2017/0203708 A1
(43) Pub. Date: Jul. 20, 2017

(54) ONE-PIECE FASCIA WITH INTEGRATED ENERGY ABSORBER

(71) Applicant: Ford Global Technologies, LLC, Dearborn, MI (US)

(72) Inventors: Dean M. JARADI, Macomb, MI (US); Mohammed Omar FARUQUE, Ann Arbor, MI (US); S.M. Iskander FAROOQ, Novi, MI (US)

(21) Appl. No.: 14/996,976

(22) Filed: Jan. 15, 2016

(51) Int. Cl. B60R 19/18; B33Y 80/00; B33Y 10/00; B60R 19/03; B29C 67/00

(52) U.S. Cl. CPC B60R 19/18; B60R 19/03; B29C 67/0066; B29C 67/0059; B29C 67/0077; B33Y 10/00; B33Y 80/00; B60R 2019/1866; B60R 2019/1886; B29L 2031/3044

(57) ABSTRACT

One-piece, integrated vehicle fascia and energy absorbers and methods of forming the same are disclosed. The one-piece vehicle fascia may include a fascia body and an energy absorber integrally formed with the fascia body. The energy absorber may include an open lattice portion including at least one lattice wall extending rearward from a front portion of the fascia body and adjoining at least two open cells. The lattice wall thickness may be smaller at a front portion of the energy absorber than at a rear portion. The open lattice portion may be formed as a honeycomb structure. The one-piece, integrated vehicle fascia and energy absorber may be formed by an additive manufacturing process (e.g., 3D printing). The process may include building the one-piece vehicle fascia in a plurality of successive layers each having a uniform thickness.

### TECHNICAL FIELD

The present disclosure relates to a one-piece fascia with an integrated energy absorber, for example, a front vehicle fascia.

### BACKGROUND

Vehicles generally include front and rear fascia (bumpers) in order to absorb energy during impacts, reduce potential injury to pedestrians, and avoid height mismatches between vehicles, among other functions. Vehicles may also include a separate energy absorber disposed between the fascia (e.g., front fascia) and the vehicle frame. The energy absorber may dissipate energy during a collision, particularly low-speed collisions. The energy may dissipate energy by deforming, thereby reducing the amount of energy transferred to the vehicle frame. The fascia and the energy absorber are typically formed of different plastic materials, although the energy absorber may also be formed of a metal. The two parts are generally formed using a plastic molding process, such as injection molding, and then joined together (e.g., by mechanical fasteners and/or adhesives).

### SUMMARY

In at least one embodiment, a one-piece vehicle fascia is provided. The fascia may include a fascia body; and an energy absorber integrally formed with the fascia body and including an open lattice portion including at least one lattice wall extending rearward from a front portion of the fascia body and adjoining at least two open cells.

The at least one lattice wall may have a thickness that varies from a front of the open lattice portion to a rear of the open lattice portion. The thickness of the at least one lattice wall may be smaller at the front of the open lattice portion than at the rear of the open lattice portion. In one embodiment, the thickness of the at least one lattice wall continuously increases from the front of the open lattice portion to the rear of the open lattice portion.

The open lattice portion may include a repeating pattern of open cells having a continuous common lattice wall. The fascia body may be formed of a first polymer and the energy absorber may be formed of a second polymer that is different from the first polymer. In another embodiment, the fascia body is formed of a polymer and the energy absorber is formed of a metal. The front portion of the fascia body may include a grill opening defined in and the energy absorber may be disposed above the grill opening. The energy absorber may include a solid portion extending upward from the open lattice portion. In one embodiment, the open lattice portion may have a thickness that is greater than a thickness of the solid portion.

In at least one embodiment, a method is provided comprising forming a one-piece vehicle fascia including a fascia body and an energy absorber integrally formed with the fascia body by an additive manufacturing process. The process may include building the one-piece vehicle fascia in a plurality of successive layers each having a uniform thickness.

The forming step may include forming an open lattice portion of the energy absorber extending rearward from a front portion of the fascia body. The forming step may include forming lattice walls extending rearward from the front portion of the fascia body and forming a thickness of the lattice walls smaller at a front of the lattice portion than at a rear of the lattice portion. In one embodiment, the forming step includes forming the open lattice portion as a honeycomb structure. In one embodiment, the additive manufacturing process includes curing a liquid polymer using a light source. In another embodiment, the additive manufacturing process includes heating a source material to at least its melting temperature and extruding the material from a nozzle. In another embodiment, the additive manufacturing process includes fusing a source material powder or melting a source material powder using a laser.

In at least one embodiment, a one-piece vehicle fascia is provided. The fascia may include a fascia body; and an energy absorber integrally formed with the fascia body and including a honeycomb structure extending rearward from a front portion of the fascia body. A wall thickness of the honeycomb structure may increase as the honeycomb structure extends rearward. The honeycomb structure may form a bottom portion of the energy absorber and the energy absorber may further include a solid top portion.

### BRIEF DESCRIPTION OF THE DRAWINGS

FIG. 1 is a perspective view of a conventional two-piece front fascia and energy absorber;

FIG. 2 is a front perspective view of a one-piece front fascia having an integrated energy absorber, according to an embodiment;

FIG. 3 is a rear view of the one-piece front fascia of FIG. 2; and

FIG. 4 is a rear perspective view of the one-piece front fascia of FIG. 2, including an enlarged view of the energy absorber.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

An example of a typical front fascia 10 and separate energy absorber 12 are shown in FIG. 1. The front fascia 10 and the energy absorber 12 are formed as two separate pieces that are later joined together, for example, by mechanical fasteners and/or adhesives. The front fascia 10 and the energy absorber 12 are generally formed of different plastics, although the energy absorber 12 may include or be formed of metal. The front fascia 10 and the energy absorber 12 are typically formed by a molding process, such as injection or compression molding. The energy absorber's main function is to dissipate energy during a collision, particularly low-speed collisions. The energy absorber 12 may dissipate energy by deforming, thereby reducing the amount of energy transferred to the vehicle frame (not shown).

Accordingly, conventional, two-piece fascia systems (fascia and energy absorber) require separate molds or die sets, which increase the cost of manufacturing and increase the footprint of the manufacturing equipment required to make the system. In addition, the two pieces must be joined in a later, separate step. The shape of the components is also limited by the conventional manufacturing methods. The conventional process is also inflexible and capital intensive to change, and does not lend itself to prototyping. Each design change may require the creation of new molds, which are expensive and time consuming to generate. Maintaining multiple molds also requires large storage spaces. As a result, it is difficult to quickly test a new design or make small changes to existing designs.

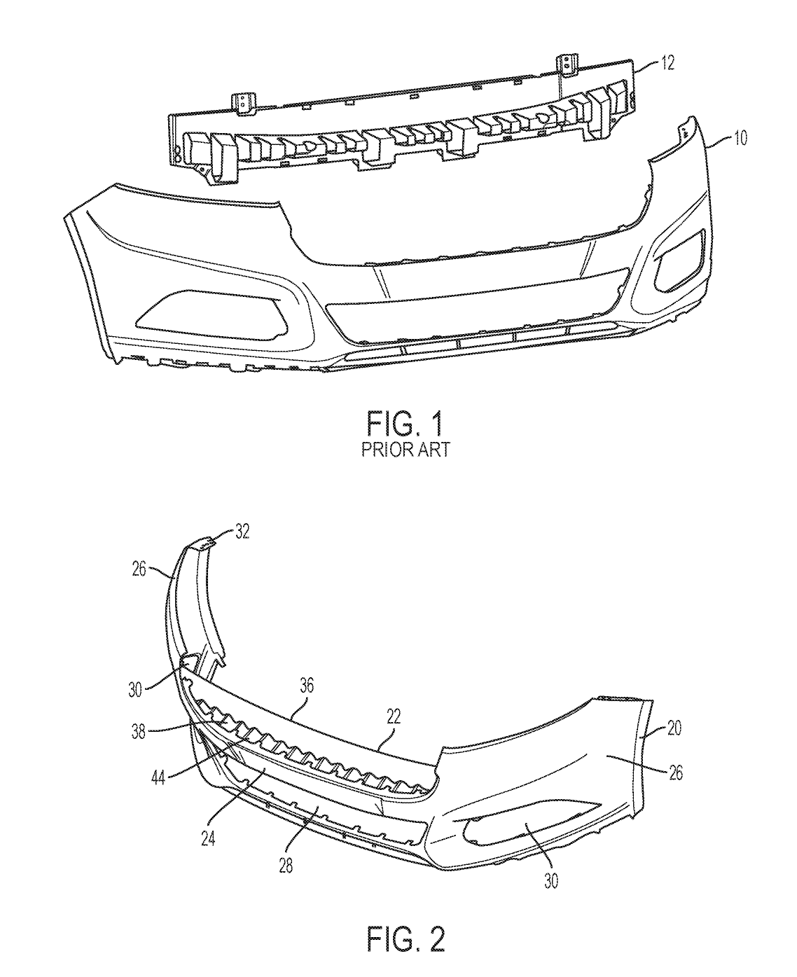

With reference to FIGS. 2-4, an embodiment of a one-piece fascia 20 is shown having an integrated energy absorber 22. The fascia 20 is shown as a front fascia, however, it may also be a rear fascia. As used herein, the terms “one-piece” and “integrated” describe an item that is unitary and continuous, not the result of connected or attaching two or more separate items. For example, as used herein, “one-piece” and “integrated” do not include two pieces that are joined by fasteners or adhesives. The terms refer to an item that is formed as a single piece using a single manufacturing process (e.g., 3D printing, described below). Accordingly, the front fascia 10 and energy absorber 12 shown in FIG. 1 and described above are not “one-piece” or “integrated” once assembled, according to the present disclosure.

The fascia 20 may include a front portion 24 and two side portions 26, which may extend from the front portion and begin to wrap around the sides of the vehicle, when attached. The front portion 24 and side portions 26 may have one or more openings defined therein to accommodate other vehicle components. For example, a grill opening 28 may be formed in the front portion 24 and headlight openings 30 may be formed in the side portions 26. However, these openings and their locations and functions are merely examples, and other openings may be formed or the openings described may be eliminated, moved, or used for other purposes. The fascia 20 may also include one or more (e.g., a plurality) flanges 32 on the front and/or side portions. The flanges 32 may provide attachment points for attaching the fascia 20 to a frame of the vehicle. The attachment may be by mechanical fasteners, such as bolts, which may be secured to holes or apertures 34 in the flanges 32. However, other attachment methods may also be used, such as adhesives.

The energy absorber 22 may extend rearward from the fascia 20 (e.g., toward the vehicle) such that it is disposed between the vehicle and the fascia 20. As described above, the energy absorber 22 may be configured to dissipate energy during a collision. The energy absorber 22 may extend across at least the front portion 24 and may extend across at least a part of the side portions 26. For example, the energy absorber 22 may extend a greater width than the grill opening 28 and may at least partially overlie the headlight openings 30. The energy absorber 22 may be disposed above the grill opening 28.

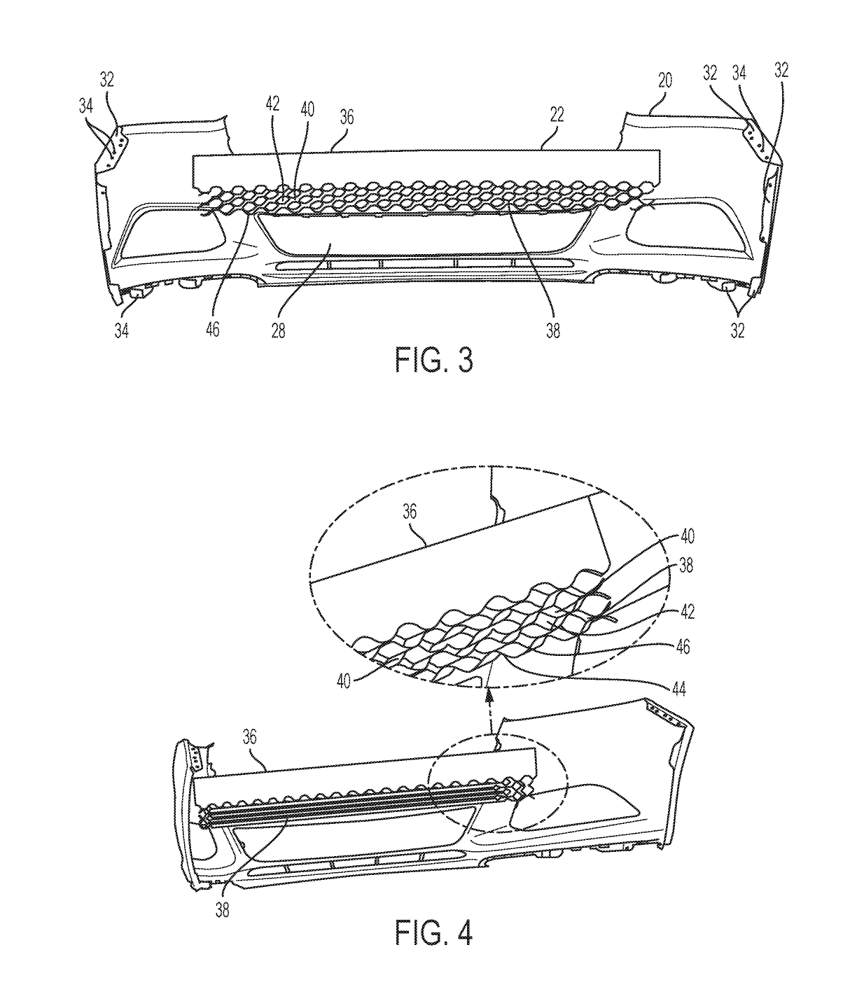

The energy absorber 22 may include a solid portion 36 and an open lattice or open cell portion 38. The solid portion 36 may form a top of the energy absorber 22 and the lattice portion 38 may form a bottom of the energy absorber 22. As shown, the solid portion 36 may be substantially rectangular in shape, however, the bottom edge of the solid portion may not be straight where it transitions to the lattice portion 38. The solid portion 36 may form from 25% to 75% of a height of the energy absorber 22, for example, 30% to 70%, 35% to 65%, 40% to 60%, 45% to 55%, or about 50% (e.g., ±5%). The lattice portion may form from 25% to 75% of a height of the energy absorber 22, for example, 30% to 70%, 35% to 65%, 40% to 60%, 45% to 55%, or about 50% (e.g., ±5%). In the embodiment shown in FIG. 3, the solid portion 36 and the lattice portion 38 each form about 50% of the height of the energy absorber 22.

The lattice portion 38 may have a greater depth than the solid portion 36, for example, as shown in FIG. 2. The lattice portion 38 may have a greater depth along a majority of the width of the energy absorber 22, such as at least along 75% of the width. As used herein, the term “solid” in the solid portion 36 may mean that there are no macro-scale holes or openings in the solid portion 36 (e.g., visible to the naked eye). The solid portion 36 may include openings to facilitate attachment of the energy absorber 22 to the vehicle frame. For example, the openings may be configured to receive fasteners, such as bolts.

The open lattice portion 38 may include at least one lattice wall 40 that extends rearward from the front portion 24 of the fascia 20. The lattice wall 40 may adjoin at least two open cells 42 formed in the open lattice portion 38. In at least one embodiment, there may be a plurality of open cells 42 having a continuous common lattice wall 40, as shown in FIGS. 3 and 4. For example, the common lattice wall 40 may define a repeating pattern of open cells 42. The plurality of open cells 42 may have the same shape in a transverse cross-section (e.g., a cross-section parallel to the width and perpendicular to the depth of the energy absorber). The open cells 42 may form a repeating 2D pattern in the front plan view that extends rearward to form the 3D shape of the energy absorber (e.g., as shown in FIGS. 2-4). The open cells 42 may also have the same dimensions in transverse cross-section.

The open cells 42 of the open lattice portion 38 may have any suitable cross-sectional or 2D shape. In at least one embodiment, the open cells 42 may be shaped as polygons (e.g., a closed plane figure bounded by three or more line segments). The polygon may be a regular polygon, such that all angles are equal and all sides are equal. Non-limiting examples of suitable polygons or regular polygons may include triangles, squares, rectangles, pentagons, hexagons, heptagon, octagons, or others. The polygons may form a repeating pattern such that each side of one polygon is shared with an adjoining polygon (except for sides that are on an end or surface). In one embodiment, the open cells 42 may be shaped as hexagons, which may be regular hexagons. The hexagons may be formed in a repeating pattern to form a honeycomb structure, as shown in FIGS. 2-4. Shapes other than polygons may also be used, such as those having curved portions. Non-limiting examples may include circles, ovals, or ellipses. In embodiments where there is a repeating pattern of open cells 42, such as a honeycomb structure, the lattice walls 40 of each open cell 42 may be continuous such that they can be considered one continuous wall that defines a plurality of open cells.

The width or thickness of the lattice walls 40 (e.g., in 2D plan view) may stay constant as the open lattice portion 38 extends rearward from the fascia 20. However, in at least some embodiments, the thickness of the lattice walls may vary from a front 44 of the open lattice portion 38 to a rear 46 of the open lattice portion 38. The variation in thickness may be continuous or discontinuous (e.g., in discrete steps). In at least one embodiment, the thickness of the lattice walls 40 may be smaller at the front 44 than the rear 46 of the open lattice portion 38. The thickness may continuously increase from the front 44 to the rear 46 (e.g., in a linear fashion) or there may be discrete or step-wise increases. The reverse configuration (e.g., thicker in front, thinner in rear) is also contemplated.

In at least one embodiment, the thickness of the lattice walls 40 may be from 0.5 to 10 mm, or any sub-range therein, such as 1 to 8 mm, 1 to 6 mm, 2 to 5 mm, or 2 to 4 mm. In one embodiment, a narrower portion of the lattice walls (e.g., the front 44) may be from 0.5 to 5 mm, or any-sub-range therein, such as 0.5 to 4 mm, 1 to 4 mm, 1 to 3 mm, or about 2 mm (e.g., ±0.5 mm). In another embodiment, a wider/thicker portion of the lattice walls (e.g., the rear 46) may be from 2 to 10 mm, or any sub-range therein, such as 2 to 8 mm, 3 to 8 mm, 3 to 7 mm, 3 to 6 mm, 3 to 5 mm, or about 4 mm (e.g., ±0.5 mm). An average wall thickness along the depth of the lattice portion may be from 1 to 6 mm, or any sub-range therein, such as 2 to 6 mm, 1 to 5 mm, 2 to 4 mm, or about 3 mm (e.g., ±0.5 mm). Having a narrower portion (e.g., at the front 44) and a thicker portion (e.g., at the rear 46) may provide improved crushing performance in the energy absorber 22. For example, tapering of the thickness such that it increases from front to rear may allow for progressive crushing of the energy absorber 22 from the front towards the rear.

In another embodiment, similar crushing performance may be achieved by changing the size of the open cells 42 instead of, or in addition to, changing the wall thickness. For example, in one embodiment the width or diameter (depending on the shape) of the open cells 42 may increase from the front 44 to the rear 46 of the energy absorber 22. The thickness of the walls 40 may stay be constant in this embodiment, or they may increase from front to rear, as well (values may be the same as those above). In one embodiment, the average cell size (e.g., width or diameter) may be from 5 to 100 mm, or any sub-range therein, such as 10 to 75 mm, 10 to 50 mm, 15 to 75 mm, 15 to 50 mm, 15 to 45 mm, 20 to 45 mm, 15 to 40 mm, or 20 to 40 mm. In embodiments where the front 44 has a smaller cell size, the cell size may be from 5 to 50 mm, or any sub-range therein, such as 5 to 40 mm, 10 to 40 mm, 10 to 35 mm, 15 to 40 mm, 15 to 35 mm, 15 to 30 mm, 15 to 25 mm, or about 20 mm (e.g., ±3 mm). In embodiments where the rear 46 has a larger cell size, the cell size may be from 15 to 100 mm, or any sub-range therein, such as 15 to 75 mm, 20 to 75 mm, 20 to 60 mm, 25 to 55 mm, 30 to 55 mm, 25 to 50 mm, 30 to 50 mm, 35 to 50 mm, 30 to 45 mm, 35 to 45 mm, or about 40 mm (e.g., ±3 mm).

The fascia 20 and the energy absorber 22 may be formed of the same or different materials. They may both be formed of a polymer, which may be the same or different. In one embodiment, the fascia 20 may be formed of a thermoplastic or thermoset. Non-limiting examples of materials that may be used for the fascia 20 include acrylonitrile butadiene styrene (ABS), nylon, polyvinyl chloride (PVC), polypropylene (PP), polyether ether ketone (PEEK), polyamide (PA), or others. The energy absorber 22 may be formed of a polymer or a metal. The polymer may be a thermoplastic or thermoset. The polymer may be one of the polymers listed for the fascia 20, although the polymers used for the fascia 20 and the energy absorber 22 may be different. Any metal that can be formed using additive manufacturing may be included in the energy absorber 22. Non-limiting examples of metals that may be used to form the energy absorber 22 may include aluminum, steel, titanium, magnesium, or alloys thereof.

The disclosed one-piece, integrated fascia and energy absorber may not be producible using conventional molding techniques, such as injection or compression moldings. For example the open lattice portion (e.g., with a honeycomb structure) may not be produced using such techniques. Accordingly, in at least one embodiment, the disclosed one-piece fascia and energy absorber may be formed by an additive manufacturing process. Additive manufacturing is also referred to as 3D printing. There are multiple types of additive manufacturing, but the processes all generally include building a three-dimensional (3D) object by dividing the object into “2D” slices and building one slice at a time, one on top of another. While these slices or layers are referred to as “2D,” each layer has a finite thickness, which may depend on the type of equipment used, the resolution of the equipment, or other factors.

In at least one embodiment, additive manufacturing includes forming a plurality of successive layers each having a uniform thickness. Additive manufacturing can be performed using a range of materials, including polymers and metals. In addition, some additive manufacturing techniques can incorporate more than one material into the final object (e.g., 2 or more materials). The additive manufacturing techniques have been classified into seven categories by the American Society for Testing and Materials (ASTM) group: “ASTM F42—Additive Manufacturing.” These seven categories include (1) Vat Photopolymerisation; (2) Material Jetting; (3) Binder Jetting; (4) Material Extrusion; (5) Powder Bed Fusion; (6) Sheet Lamination; and (7) Directed Energy Deposition. Several techniques will be described in greater detail below, however, any technique in the above categories may be used to form the disclosed one-piece fascia and energy absorber.

In one embodiment, the additive manufacturing process may include curing a liquid polymer using a source of electromagnetic radiation, such as light. The light may be visible light, UV light, infrared, or others. The light may be in any suitable form, such as a laser. In vat photopolymerisation, a container (vat) of liquid polymer may be cured one layer at a time using a light source, such as a UV laser. In one embodiment, the one-piece fascia and energy absorber may be generated using stereolithography (SLA). SLA is a vat photopolymerisation technique that uses an ultraviolet laser to create the object one layer at a time. To form each layer, the light source (e.g., a laser beam) may trace a two-dimensional shape corresponding to a certain cross-section of the object on the surface of the uncured polymer vat. The light (e.g., UV) may cure 2D shape traced on the polymer to create a hardened layer having a certain thickness. The first layer may be formed on a substrate, while subsequent layers are cured on top of the previous layer. After each layer is cured, a platform may lower the partially formed object by the depth of a single layer. Uncured polymer may cover the partially formed object such that a new layer can be formed. The process is repeated until a fully formed object is created.

In another embodiment, the one-piece fascia and energy absorber may be generated using material jetting. Similar to SLA, material jetting includes curing an uncured polymer using light, such as UV light (e.g., by laser). Material jetting may include depositing small amounts of uncured polymer using an inkjet-printer type nozzle. The nozzle may place the uncured material in a predetermined 2D pattern to form a layer of an object. The light source may then quickly cure the polymer after it is deposited to lock it in place and bond it to the previous layer.

In another embodiment, the one-piece fascia and energy absorber may be generated by heating a source material to at least its melting temperature and extruding the material from a nozzle. One example of such a technique is fused deposition modeling (FDM). FDM uses a filament or wire, which may be a polymer or metal, which is fed to an extrusion nozzle. The nozzle is heated to melt the material and deposit it in the shape of a 2D layer. The melted material cools and solidifies as it leaves the nozzle to form each layer of the object.

In another embodiment, the one-piece fascia and energy absorber may be generated by fusing a source material powder or melting a source material powder using a heat source (e.g., a laser). One example of powder bed fusion that operates on this principle is selective laser sintering (SLS). SLS generally includes using a laser to sinter or fuse powders into a 2D layer of an object. SLS may be used with plastic and/or metal powders. After the laser scans each 2D layer, the powder bed may be lowered by one layer thickness and a new layer of powder introduced onto the partially formed object and the next layer in sintered. Selective layer melting (SLM) is similar to SLS, except that instead of sintering the material, the material is melted and then cools to solidify in the desired shape.

The additive manufacturing techniques described above may all be implemented using 3D models, for example, created or generated by a computer aided design (CAD) program. The techniques may use a numerically controlled mechanism, which may be controlled by a computer-aided manufacturing (CAM) program. Accordingly, the additive manufacturing processes described above may use a special purpose or specially adapted computer system that is programmed or configured to carry out layer-by-layer additive manufacturing steps. The controller programming may vary depending on the type of additive manufacturing process being used. The additive manufacturing process may include using a programmable robotic arm.

The disclosed one-piece integrated fascia and energy absorber has numerous benefits over conventional two-piece system. As described above, separately forming the fascia and energy absorber using conventional processes requires costly and large molds. These molds are specific to one part geometry, therefore, numerous molds need to be formed and stored for multiple designs. This not only requires significant capital investment, it is time consuming and inflexible. By forming a one-piece, integrated fascia and energy absorber using additive manufacturing, no expensive molds need to be formed or stored. In addition, design changes are simple to implement, since only the 3D model needs to be updated, which can be done using only computer software and/or hardware.

In addition to cost savings and increased flexibility, additive manufacturing may allow part designs that are not possible or are practically infeasible using conventional manufacturing methods. The disclosed one-piece, integral fascia and energy absorber would not be producible using conventional molding techniques. For example, the honeycomb structure shown in FIGS. 2-4 cannot be injection or compression molded. In addition, changes to the cell and/or wall thickness can be made within the energy absorber. For example, the wall thickness and/or the cell size may be increased from the front to the rear of the energy absorber. Accordingly, designs having performance improvements over conventional designs may be produced using additive manufacturing. In addition, new designs or design tweaks can be quickly implemented and tested, without waiting for new, costly molds to be formed.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A one-piece vehicle fascia, comprising:
a fascia body; and
an energy absorber integrally formed with the fascia body and including an open lattice portion including at least one lattice wall extending rearward from a front portion of the fascia body and adjoining at least two open cells.

2. The fascia of claim 1, wherein the at least one lattice wall has a thickness that varies from a front of the open lattice portion to a rear of the open lattice portion.

3. The fascia of claim 2, wherein the thickness of the at least one lattice wall is smaller at the front of the open lattice portion than at the rear of the open lattice portion.

4. The fascia of claim 3, wherein the thickness of the at least one lattice wall continuously increases from the front of the open lattice portion to the rear of the open lattice portion.

5. The fascia of claim 1, wherein the open lattice portion includes a repeating pattern of open cells having a continuous common lattice wall.

6. The fascia of claim 1, wherein the fascia body is formed of a first polymer and the energy absorber is formed of a second polymer that is different from the first polymer.

7. The fascia of claim 1, wherein the fascia body is formed of a polymer and the energy absorber is formed of a metal.

8. The fascia of claim 1, wherein the front portion of the fascia body includes a grill opening defined in and the energy absorber is disposed above the grill opening.

9. The fascia of claim 1, wherein the energy absorber includes a solid portion extending upward from the open lattice portion.

10. The fascia of claim 9, wherein the open lattice portion has a thickness that is greater than a thickness of the solid portion.

11. A method, comprising:
forming a one-piece vehicle fascia including a fascia body and an energy absorber integrally formed with the fascia body by an additive manufacturing process, the process including building the one-piece vehicle fascia in a plurality of successive layers each having a uniform thickness.

12. The method of claim 11, wherein the forming step includes forming an open lattice portion of the energy absorber extending rearward from a front portion of the fascia body.

13. The method of claim 12, wherein the forming step includes forming lattice walls extending rearward from the front portion of the fascia body and forming a thickness of the lattice walls smaller at a front of the lattice portion than at a rear of the lattice portion.

14. The method of claim 12, wherein the forming step includes forming the open lattice portion as a honeycomb structure.

15. The method of claim 11, wherein the additive manufacturing process includes curing a liquid polymer using a light source.

16. The method of claim 11, wherein the additive manufacturing process includes heating a source material to at least its melting temperature and extruding the material from a nozzle.

17. The method of claim 11, wherein the additive manufacturing process includes fusing a source material powder or melting a source material powder using a laser.

18. A one-piece vehicle fascia, comprising:
a fascia body; and
an energy absorber integrally formed with the fascia body and including a honeycomb structure extending rearward from a front portion of the fascia body.

19. The fascia of claim 18, wherein a wall thickness of the honeycomb structure increases as the honeycomb structure extends rearward.

20. The fascia of claim 18, wherein the honeycomb structure forms a bottom portion of the energy absorber and the energy absorber further includes a solid top portion.
